(19) United States
(12) Patent Application Publication
(10) Pub. No.: US 2003/0192468 A1
(43) Pub. Date: Oct. 16, 2003

(54) Container having time, day, date or dose indicator

(76) Inventor: Arthur G. Goertzen, Ahwahnee, CA (US)

Correspondence Address: Arthur Goertzen, PO 622, Ahwahnee, CA, 93601, US

(21) Appl. No.: 10/122,063

(22) Filed: Apr. 11, 2002

(51) Int. Cl. G09F 9/00

(52) U.S. Cl. 116/309

(57) ABSTRACT

An elastic O-ring or other expandable type ring indicator is disclosed that has indicia around its periphery identifying time, day, date or dose intervals. The ring is secured around either a cap or a neck of a conventional medicine or pill bottle. The cap or neck is provided with a pointer. The user then rotates the cap relative to the container to line up the pointer with the appropriate indicia on the ring. In another embodiment the user rotates the O-ring relative to the container or the cap to line up the pointer with the appropriate indicia on the ring. The ring is reusable and fits on conventional containers and caps.

### FIELD OF THE INVENTION

This invention relates to containers such as those for medicine and pills and, in particular, to an indicator for selectively indicating a time, day, date or dose on the container or cap.

### BACKGROUND OF THE INVENTION

Persons who must take medicine or pills at various times of the day or on certain dates may find it difficult to remember the last time that a dose or a pill was taken. There are numerous patents on caps with special windows or timers to keep track of the time of the last dose or pill taken. However, all of these techniques require a non-conventional cap that must be purchased. As a result of this extra effort and expense, such time/dosage indicators have not been commercially viable.

Examples of prior art caps, which are incorporated herein by reference, include U.S. Pat. Nos. 3,766,882; 2,767,680; 5,299,701; 3,960,713; 4,641,759; 3,151,599; 4,345,541; 5,386,795; 4,749,093; 6,003,467; 4,432,300; 4,528,933; and 6,068,149.

Thus, what is needed is a time/dosage indicator that does not suffer from the above-mentioned drawbacks.

### SUMMARY

An elastic O-ring or flexible collar indicator is described that fits snuggly around the periphery of the cap or the neck of a conventional pill container. This O-ring or collar has printed or marked on it suitable indicia, such as days of the week, hours of the day, or days of the month. If the indicator is secured around the neck of the container, the cap is marked with a pointer, and the user rotates the cap so as to point to the appropriate day or time on the O-ring or collar. In one embodiment, the user turns the cap to point to the time, day, or date of the last dose taken.

If the O-ring or collar indicator is placed around the cap, the bottle itself will have a pointer marked on it.

In one embodiment, the cap is the type that includes a child-proof ratchet mechanism inside the cap, where the cap can be rotated in discrete steps if the cap is not pushed down to engage the ratchet. In another embodiment, friction between the cap and the container prevents the cap from freely rotating.

### BRIEF DESCRIPTION OF THE DRAWINGS

FIG. 1 is a perspective view of an elastic O-ring having time intervals or days printed around its periphery.

FIG. 2 illustrates a conventional medicine bottle.

FIG. 3 illustrates the bottle of FIG. 2 having the O-ring of FIG. 1 fitted around its neck and the cap marked with a pointer to point to the hour or day that the last pill was taken.

FIG. 4 is an embodiment where the O-ring is fitted around the cap itself, and a pointer is marked on the bottle.

FIG. 5 is an example of a flexible plastic collar that may be fitted around the neck of a bottle or a cap.

### DETAILED DESCRIPTION

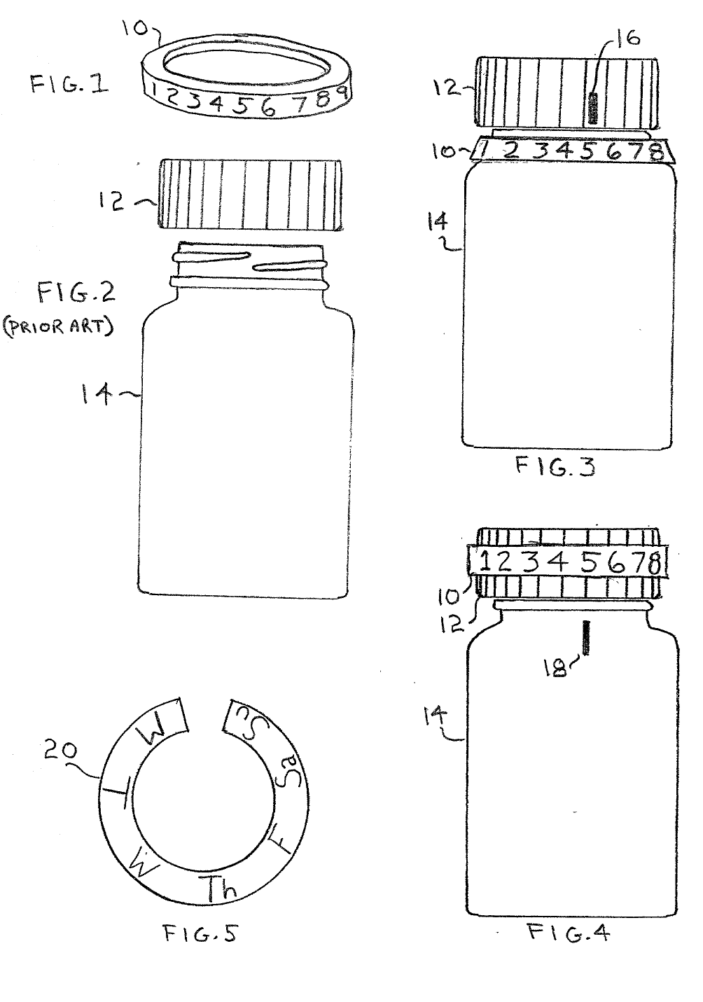

FIG. 1 is a perspective view of an elastic O-ring 10 sized to fit snuggly around a conventional plastic cap 12 (FIG. 2) or neck of a conventional plastic container 14 of the type that contain pills or other forms of medicine. O-ring 10 is typically made of rubber, neoprene, or other known elastic material. In one embodiment, the inner dimension of O-ring 10 is 1⅜ inch and the outer dimension is 2 inches.

FIG. 3 illustrates O-ring 10 fitted around the neck of container 14 so as to not freely rotate. Cap 12 is a conventional child-proof cap that has a ratchet assembly within the cap and requires one to push down on the cap in order to engage the ratchet and rotate the cap off of the neck of container 14. Examples of a ratcheted cap are described in the prior art identified above and need not be described in detail.

When the cap is not pushed down, but is rotated, the ratchet and pawl assembly does not engage, and the cap rides over the ridges of the ratchet and sets in discrete positions as the cap is rotated. The time/date indicia on O-ring 10 is spaced so that a pointer 16 marked on cap 12 aligns with each successive indicia as the cap is rotated without pressing down on the cap. Pointer 16 may be either printed on the cap or just marked with a marker or tape by the user. After the user has taken a pill at, for example, 5:00 o'clock, the user replaces the cap and rotates the cap so that pointer 16 aligns with the time of 5:00 o'clock marked on O-ring 10. The markings on the O-ring 10 may also correspond to days of the week or days of the month or other intervals. In this manner, the user knows when the last pill has been taken. In another embodiment the pointer 16 would be replaced with pointer 18 as shown in FIG. 4 and the o-ring 10 would be snug but loose enough to be rotated in order to align the desired indicia with pointer 18.

FIG. 4 illustrates an embodiment where O-ring 10 is placed around cap 12, and a pointer 18 is marked directly on container 14.

Any generally ring-shaped elastic indicator may be used instead of O-ring 10, such as the plastic ring 20 in FIG. 5, which is sized to fit around the neck of container 14. The embodiment of FIG. 5 is marked with the days of the week on the top surface but could be just as well marked on the vertical surface as illustrated by O-ring 10.

Many other embodiments of replaceable indicators that secure to conventional bottles and caps are also envisioned by the inventor. The present invention allows the indicator to be removed from one container or cap and placed on a different container or cap. The replaceable indicator may come in various sizes and may be packaged in a variety pack so that one purchase may provide all the indicators that the user will ever need.

While particular embodiments of the invention have been described herein, other embodiments will become obvious to those skilled in the art, and the invention is limited only by the following claims.

What is claimed is:

1. A method comprising:
frictionally securing a flexible ring around one of a cap or a neck of a container, said ring having indicia around its periphery identifying intervals; and
aligning a pointer indicia on one of said cap or said container with said indicia on said ring as said cap is rotated with respect to said container.

2. The method of claim 1 wherein said ring is frictionally secured to said neck of said container, and said pointer is on said cap.

3. The method of claim 1 wherein said ring is frictionally secured to said cap, and said pointer is marked on said container.

4. The method of claim 1 wherein said ring is an elastic O-ting.

5. The method of claim 4 wherein said O-ring is made of rubber.

6. The method of claim 1 wherein said ring is a disk with a cut-out section to allow expansion of said disk to fit snugly around a neck of a container, wherein said pointer indicia is located on said cap.

7. The method of claim 1 wherein said cap is rotated in discrete intervals with respect to said neck of said container.

8. The method of claim 7 wherein a ratchet mechanism within said cap enables rotation of said cap in discrete intervals.

9. A cap and container assembly comprising:
a removable flexible ring frictionally secured around one of a cap or a neck of a container, said ring having indicia around its periphery identifying intervals; and
a pointer indicia on one of said cap or said container for aligning with said indicia on said ring as said cap or said ring is rotated with respect to said container.

10. The assembly of claim 9 wherein said ring is frictionally secured to said neck of said container, and said pointer is on said cap.

11. The assembly of claim 9 wherein said ring is frictionally secured to said cap, and said pointer is marked on said container.

12. The assembly of claim 9 wherein said ring is an elastic O-ring.

13. The assembly of claim 12 wherein said O-ring is made of rubber.

14. The assembly of claim 9 wherein said ring is a disk with a cut-out section to allow expansion of said disk to fit snugly around a neck of said container, wherein said pointer indicia is located on said cap.

15. The assembly of claim 9 wherein said cap is rotated in discrete intervals with respect to said neck of said container.

16. The assembly of claim 15 wherein a ratchet mechanism within said cap enables rotation of said cap in discrete intervals.
